(19) United States
(12) Patent Application Publication
(10) Pub. No.: US 2012/0049019 A1
(43) Pub. Date: Mar. 1, 2012

(54) MOUNTING DEVICE FOR HOLDING OBJECT

(75) Inventor: Jeong-Shiun Chen, Taipei (TW)

(73) Assignee: SUPA Technology Co., Ltd., Taipei (TW)

(21) Appl. No.: 12/862,910

(22) Filed: Aug. 25, 2010

(51) Int. Cl. F16B 47/00

(52) U.S. Cl. 248/206.2

(57) ABSTRACT

A mounting device includes an attaching unit having a suction disk assembly and a support arm which has a joint member on a free end thereof. A securing unit has a hollow case and a movable member disposed in the hollow case so as to define a first chamber and a second chamber in the hollow case. The joint member is received in the first chamber. The hollow case is pivotable relative to the joint member. A pressing member is disposed in the second chamber and can force the movable member to securely fix the joint member between the hollow case and the movable member. A holding unit is connected to the hollow case and a communication product is held by the holding unit. The holding unit is moved with the hollow case and the communication product is adjusted to an optimal angle.

### BACKGROUND OF THE INVENTION

1. Field of the Invention

The present invention relates generally to a mounting device, and in particular to a windshield mount or a dashboard mount to hold a communication product.

2. The Prior Arts

Communication products such as cellular phones, PDA's, and GPS devices are used widely and gaining popularity. Users can use the communication products at any place and at any time.

However, when the user drives or takes a vehicle, the user usually puts the communication product on a dashboard mount or a windshield mount. Conventional vehicle mounting device can securely hold the communication product in vehicle, but it needs a switch to control spinning the communication product toward the user and another switch to control rotating the communication product to a pitch angle for better viewing. Therefore, the user has to loosen two switches and then adjust the communication product to an optimal viewing orientation. It is inconvenient for the users to operate the two switches to adjust the angle.

Due to the inconvenience, the present invention provides a mounting device that allows the user to adjust the communication product to an optimal angular position without operating two switches.

### SUMMARY OF THE INVENTION

A primary objective of the present invention is to provide a mounting device for a communication product that is easy to adjust the viewing angle of the communication product. The mounting device according to the present invention only needs one switch to control spinning the communication product toward a user and rotating the communication product to an optimal pitch angle.

Another objective of the present invention is to provide a mounting device that is easy to be fixed on surfaces of various objects, easy to be removed from the surfaces and easy to carry.

Still another objective of the present invention is to provide a mounting device which is capable of securing various objects and the mounting device is easily manufactured and operated.

In order to achieve the objectives, a mounting device according to the present invention includes an attaching unit, a securing unit and a holding unit. The attaching unit has a suction disk assembly and a support arm which has a joint member on a free end thereof. A securing unit has a hollow case and a movable member is disposed in the hollow case so as to define a first chamber and a second chamber in the hollow case. The joint member is received in the first chamber. The hollow case can spin and rotate relative to the joint member. A pressing member is located in the second chamber and forces the movable member to secure the joint member between the hollow case and the movable member. Thus the hollow case is fixed relative to the joint member. The holding unit is connected to the hollow case and a communication product is secured on the holding unit. The holding unit is moved with the hollow case and the communication product is adjusted to an optimal viewing angle.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a mounting device in accordance with the present invention;

FIG. 2 is an exploded view showing the mounting device in accordance with the present invention;

FIG. 3 is another exploded view showing the mounting device in accordance with the present invention;

FIG. 4 is a side view showing the mounting device according to the present invention is not sucked on a surface and is free to adjust orientation of a communication product;

FIG. 5 is a cross sectional view showing the mounting device of FIG. 4;

FIG. 6 a side view showing the mounting device according to the present invention is sucked on a surface and cannot adjust orientation of a communication product;

FIG. 7 is a cross sectional view showing the mounting device of FIG. 6; and

FIG. 8 is a perspective view showing that the mounting device is connected to a windshield and a communication product is clamped by the mounting device.

### DETAILED DESCRIPTION OF THE PREFERRED EMBODIMENT

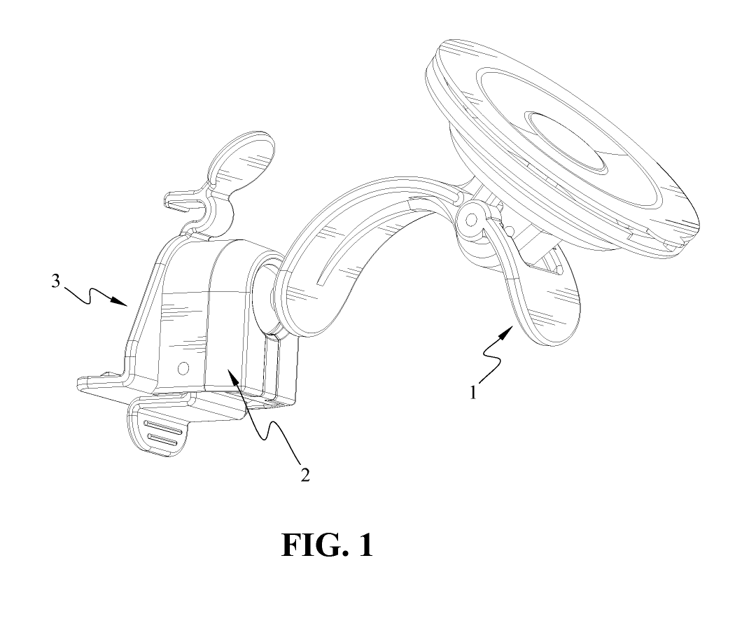

With reference to the drawings and in particular to FIG. 1, a mounting device for holding an object in accordance with the present invention comprises an attaching unit 1, a securing unit 2, and a holding unit 3. The securing unit 2 and the holding unit 3 can simultaneously move relative to the attaching unit 1, thereby adjusting angular position of the object.

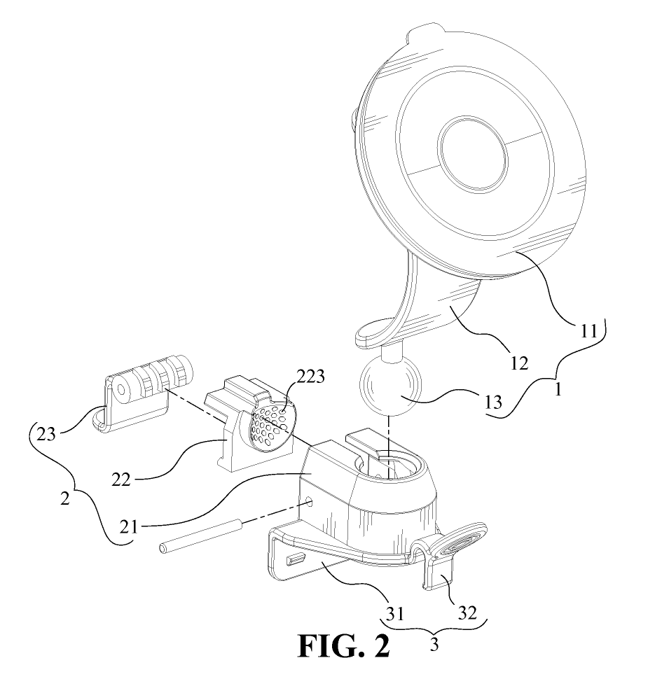

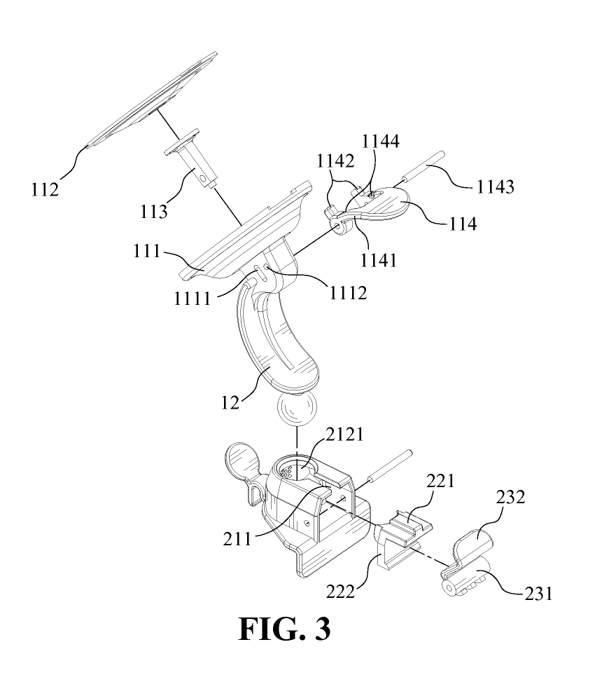

Referring to FIGS. 2 and 3, the attaching unit 1 comprises a suction disk assembly 11 and a support arm 12 which has a joint member 13 at a free end thereof.

The suction disk assembly 11 comprises a disk frame 111, a suction disk 112 and a link 113. The link 113 is disposed between and connects the disk frame 111 and the suction disk 112. A U-shaped lever 114 includes two arms 1141 which are pivotably connected to the disk frame 111. Each arm 1141 has a protrusion 1142 and a pin 1143 passes through the two arms 1141, a rear portion of the disk frame 111 and an end of the link 113. The rear portion of the disk frame 111 and the end of the link 113 are located between the two arms 1141. The rear portion of disk frame 111 includes a slot 1111 and the pin 1143 extends through the slot 1111. When the lever 114 is pivoted upward, the protrusions 1142 is pressed against the disk frame 111 so that the pin 1143 moves to the rear end of the slot 1111 and the link 113 and the suction disk 112 are pulled backward. When the lever 114 is pivoted downward, the suction disk 112 and the link 113 are moved forward. Besides, a recess 1144 is defined in each arm 1141 and the disk frame 111 has two bosses 1112 corresponding to the recesses 1144. When the lever 114 is pivoted upward, the bosses 1112 are engaged with the recesses 1144 to prevent the lever 114 from over pivoting.

The support arm 12 is integrally formed with the disk frame 111. According to a preferred embodiment, the support arm 12 has a curved shape. The joint member 13 is preferred to have a curved surface and the joint member 13 according to the preferred embodiment is a ball.

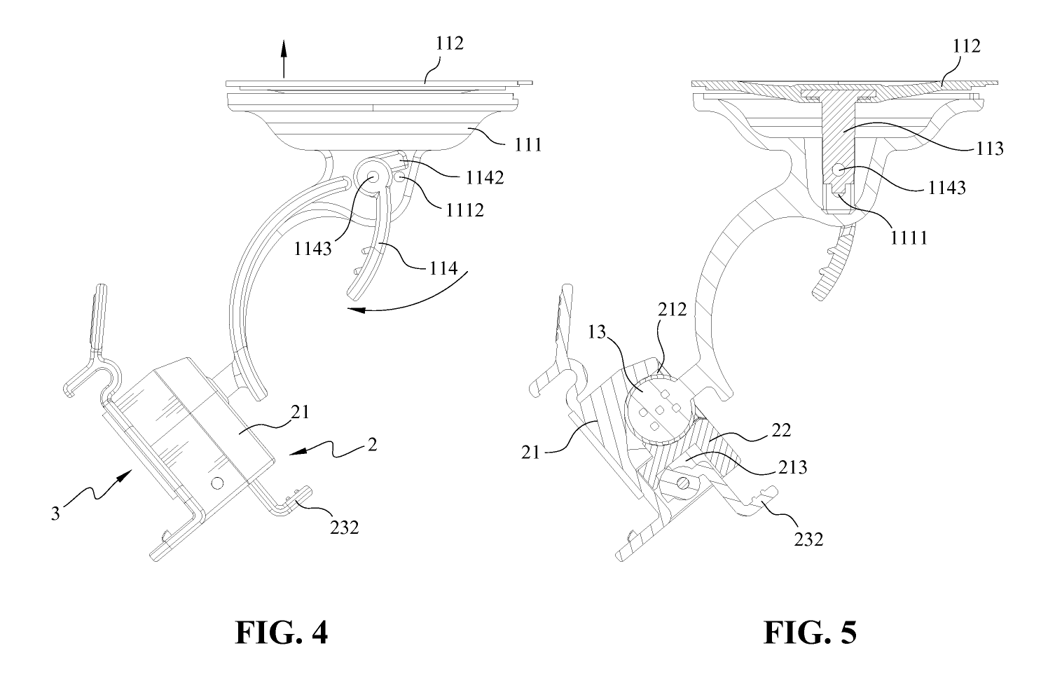

The securing unit 2 comprises a hollow case 21, a movable member 22 and a pressing member 23. The hollow case 21 has an open end and a groove 211 communicates with the open end. The movable member 22 has a vertical extension 222 and a horizontal dove-tailed part 221 which is slidably engaged with the groove 211 of the hollow case 21. The extension 222 has a spherical concave 223. The movable member 22 is received in the hollow case 21 so as to define a first chamber 212 and a second chamber 213 in the hollow case 21 as shown in FIG. 5. The first chamber 212 has a spherical recess 2121 corresponding to the spherical concave 223. The joint member 13 slidably received in the first chamber 212 and disposed between the spherical recess 2121 and the spherical concave 223. Therefore, the hollow case 21 can rotate and spin relative to the joint member 13 in different directions. The pressing member 23 comprises an integral pivot 231 and a handle 232. The pivot 231 is pivotably engaged with the second chamber 213. Generally, the handle 232 is parallel or perpendicular to the hollow case 21 as shown in FIGS. 4-7.

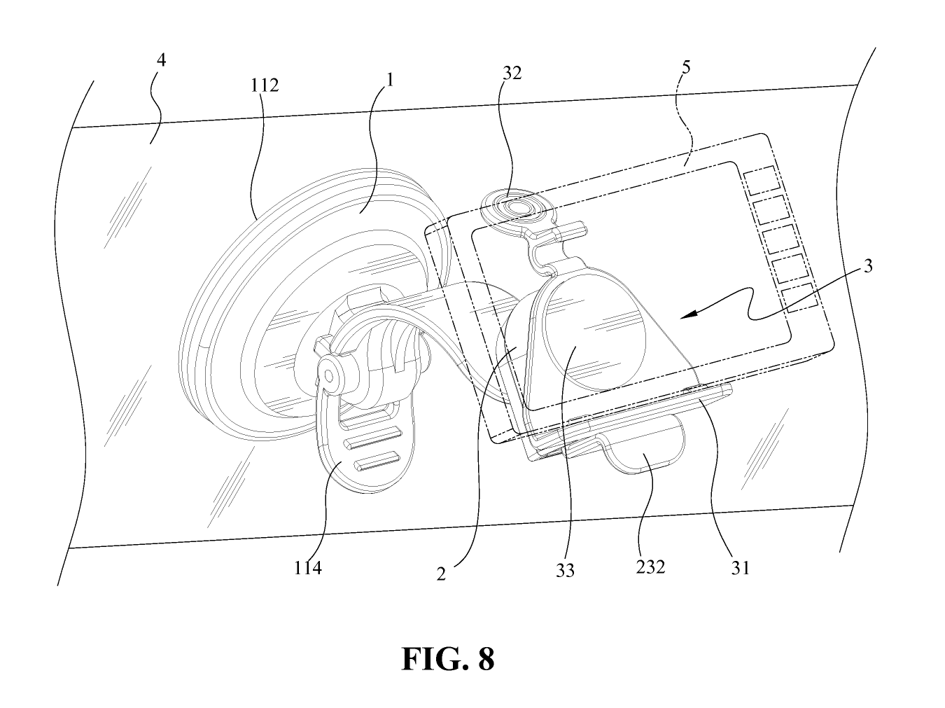

The holding unit 3 is disposed at a rear side of the hollow case 21 and includes a support plate 31 and a clamping member 32. The shape of the support plate 31 can be any desired shape and a soft pad 33 is attached on the support plate 31 as shown in FIG. 8 so that the communication product is in contact with the soft pad 33. The clamping member 32 is flexible. Therefore, when the communication is disposed on the support plate 31, a part of the communication product is clamped by the clamping member 32. The communication product is a GPS in this embodiment. According to an embodiment, a hook portion of the clamping member 32 is engaged with a slot of the GPS and a disk portion of the clamping member 32 can disengage the hook portion from the GPS. According to another embodiment, the hook portion of the clamping member 32 may clamp an edge of the GPS 5. The support plate 31 can be manufactured to be a larger size so as to clamp a book or a document file for example.

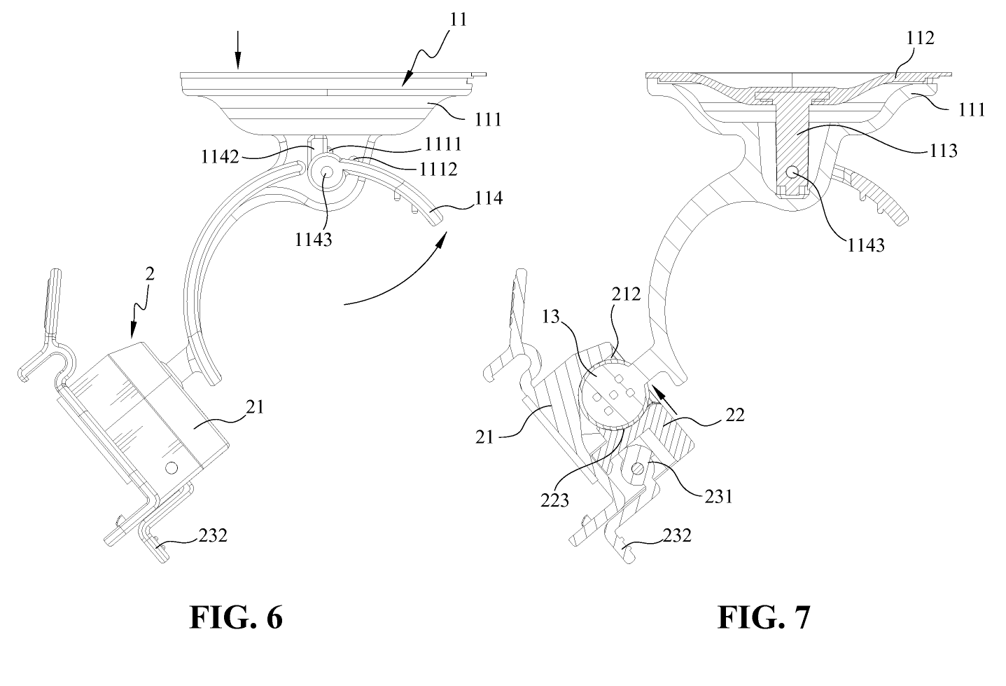

FIGS. 4 and 5 show the attaching unit 1 is not fixed on a surface. The protrusions 1142 of the lever 114 contact with the bosses 1112 of the disk frame 111 and the pin 1143 is located in the upper end of the slot 1111. The link 113 pulls the suction disk 112 away from the disk frame 111. The handle 232 of the securing unit 2 is parallel to the hollow case 21 and is not yet in contact with the movable member 22. Because the joint member 13 is slidably engaged with the first chamber 212, the hollow case 21 can be rotated or spun relative to the joint member 13. Thus, the holding unit 3 can spin toward a user and rotate a pitch angle for an optimal viewing angle. FIGS. 6 and 7 show the attaching unit 1 is fixed on a surface. When pivoting the lever 114 upward as shown in FIGS. 6 and 7, the protrusions 1142 is pressed against the disk frame 111 and the pin 1143 moves to the lower end of the slot 1111. The suction disk 112 and the link 113 are moved toward the disk frame 111. Thus, a vacuum is pulled in the suction disk 112 and the suction disk 112 is suck on a surface. Referring to FIG. 3, the bosses 1112 and the recesses 1144 can prevent the lever 114 from over pivoting. Thus, it keeps the suction disk 112 in an operative vacuum status, thereby attaching the attaching unit 1 on the surface. For the securing unit 2, the handle 232 is pivoted to be perpendicular to the hollow case 21. During the pivoting, the pivot 231 is pressed against the movable member 22 so that the dove-tailed part 221 moves along the groove 211 to let the spherical concave 223 and the spherical recess 2121 of the first chamber 212 clamp the joint member 13. After the joint member 13 is clamped, the hollow case 21 cannot rotate or spin relative to the joint member 13.

Referring to FIG. 8, the suction disk 112 of the attaching unit 1 is attached on a windshield 4 of a vehicle by pivoting the lever 114. A GPS 5 is then put on the support plate 31 of the holding unit 3. Before the securing unit 2 is operated, the position of the GPS 5 on the holding unit 3 is adjustable by rotating the ball-shaped joint member 13. Thus, the user can spin the GPS 5 on the holding unit 3 in a horizontal plane and rotate the GPS 5 to a pitch angle until the GPS 5 is adjusted to an optimal viewing angle. Then, the position of the GPS 5 is fixed by pivoting the lever 232. The GPS 5 can be adjusted to various angular positions and the users simply pivoting the lever 114 and the handle 232 to set the suction disk 112 and the securing unit 2. The user does not need to leave the seat or turn his/her body to adjust the angular position of the GPS 5. The mounting device according to the present invention is not limited to hold the communication product, such as the GPS and the cellular phone. For example, the holding unit 3 can be slightly amended to make the clamping member 32 to clamp different object such as a document file and a book. The suction disk 112 can suck on a monitor, a laptop or other surfaces.

Although the present invention has been described with reference to the preferred embodiment thereof, it is apparent to those skilled in the art that a variety of modifications and changes may be made without departing from the scope of the present invention which is intended to be defined by the appended claims

What is claimed is:

1. A mounting device for holding an object, comprising:
an attaching unit having a suction disk assembly and a support arm which has a joint member on a free end thereof;
a securing unit having a hollow case and a movable member disposed in the hollow case so as to define a first chamber and a second chamber in the hollow case, the joint member received in the first chamber, the hollow case capable of spinning and rotating relative to the joint member, a pressing member received in the second chamber, the pressing member capable of forcing the movable member to securely fix the joint member between the hollow case and the movable member such that the hollow case is incapable of spinning or rotating relative to the joint member; and
a holding unit disposed by the hollow case to hold the object and moved with the hollow case.

2. The mounting device as claimed in claim 1, wherein the joint member is slidably engaged with the first chamber.

3. The mounting device as claimed in claim 1, wherein the joint member is a spherical member and the first chamber has a spherical recess.

4. The mounting device as claimed in claim 3, wherein the movable member comprises a spherical concave corresponding to the spherical recess of the first chamber.

5. The mounting device as claimed in claim 1, wherein the hollow case has an open end and a groove communicating with the open end, the movable member has a dove-tailed part which is slidably engaged with the groove.

6. The mounting device as claimed in claim 1, wherein the pressing member comprises a pivot and a handle, the pivot is pivotably engaged with the second chamber, the pivot is pressed against the movable member when pivoting the handle.

7. The mounting device as claimed in claim 1, wherein the suction disk assembly comprises a disk frame and a suction disk, a link is connected between the disk frame and the suction disk, a pin passes through the lever and the link in the disk frame, when the lever is pivoted, the lever is pressed against the disk frame and pulls the link and the suction disk so that the suction disk sucks on a surface.

8. The mounting device as claimed in claim 7, wherein the lever includes two arms which are pivotably connected to the disk frame and each arm has a protrusion and a recess, the disk frame has two bosses corresponding to the recesses, when the lever is pivoted, the protrusions is pressed against the disk frame until the bosses are engaged with the recesses, the suction disk sucks on the flat surface.

9. The mounting device as claimed in claim 1, wherein the holding unit and the hollow case are integrally formed, and the holding unit includes a support plate and a clamping member to clamp the object.

10. The mounting device as claimed in claim 1, wherein the hollow case is capable of spinning in a horizontal plane and rotating a pitch angle relative to the joint member.
